(19) United States
(12) Patent Application Publication
(10) Pub. No.: US 2002/0079205 A1
(43) Pub. Date: Jun. 27, 2002

(54) Switching contact for electrical switching devices

(76) Inventors: Karl-Heinz Gunzelmann, Nurnberg (DE); Manfred Knofel, Kummersbruck (DE); Wolfgang Schlenk, Erlangen (DE)

Correspondence Address: LERNER AND GREENBERG, P.A., Post Office Box 2480, Hollywood, FL, 33022-2480, US

(21) Appl. No.: 09/968,303

(22) Filed: Oct. 1, 2001

Related U.S. Application Data
(63) Continuation of application No. PCT/DE00/00869, filed on Mar. 21, 2000.

(30) Foreign Application Priority Data
Mar. 29, 1999 (DE) 199 14 251.3

(51) Int. Cl. H01H 1/06

(52) U.S. Cl. 200/275

(57) ABSTRACT

The switching contact is suitable for electrical switching devices. A contact element is connected to a contact support. In order to connect relatively large contact elements to the contact support with sufficient connection quality, in particular by means of cost-effective resistance welding or laser welding, the contact element is formed from a number of contact element segments and the individual contact element segments are assembled to make up the contact element. Different switching properties can be set by using contact element segments of the same or different material compositions and/or geometries.

### CROSS-REFERENCE TO RELATED APPLICATION

This application is a continuation of copending International Application No. PCT/DE00/00869, filed Mar. 21, 2000, which designated the United States.

### BACKGROUND OF THE INVENTION

1. Field of the Invention

The present invention relates to a switching contact for electrical switching devices. The switching contact or switch contact has a contact element connected to a contact support.

Contact elements used for switching contacts of this type are not uncommonly greater than or equal to 16 mm² in size. It has hitherto only been possible to connect contact elements of such sizes to the contact supports in a complicated and consequently costly way. In particular with cost-effective types of connection, such as for example resistance welding, so far it has not been possible to produce connections of sufficient connection quality between contact elements of such a size and contact supports.

Therefore, for the production of such switching contacts, firstly a homogeneous rolled or sintered contact element with appropriate switching properties must be produced and subsequently connected to the contact support by means of a soldered connection. However, production is relatively complex and also cost- and time-intensive. Furthermore, internal stresses in the contact element are induced by the production process mentioned and may lead to contact material being dislodged from the contact element if it is subjected to high switching loads.

German published patent application DE 15 39 783 discloses switching contacts for electrical switching devices which comprise for example a rectangular carbon contact and a hemispherical metallic counterpart. The carbon contact is either formed in one piece or it comprises two halves which are assembled to make up a contact element without any spaces in between.

### SUMMARY OF THE INVENTION

It is accordingly an object of the invention to provide a switch contact for electrical switching devices, which overcomes the above-mentioned disadvantages of the heretofore-known devices and methods of this general type and which is easy to manufacture yet provides for superior switching contact characteristics.

With the foregoing and other objects in view there is provided, in accordance with the invention, a switching contact for an electrical switching device, comprising:

a contact support;

a contact element connected to the contact support with a welded connection, the contact element being formed of a plurality of contact element segments with individual the contact element segments assembled to form the contact element.

In other words, the objects are achieved with a contact element that is formed by a plurality of contact element segments. Individual contact element segments are assembled to make up the contact element and the contact element is connected to the contact support by means of a welded connection.

The underlying idea of the present invention is that the contact element, and consequently the switching surface formed by the contact element, is divided into a plurality of smaller individual segments. These small individual segments can then be connected to the contact support cost-effectively by welding. This allows the costs for the production of switching contacts to be reduced considerably. Furthermore, the segmenting of the contact element achieves the effect that the internal stresses in the contact element, or in the contact surface, are reduced in such a way that detachment of contact material from the contact element is reduced even under high switching loads.

By assembling the contact element from a plurality of contact element segments, contact elements with a switching surface of virtually any desired size, or any desired switching geometry, can be created. In addition, the cost-effectiveness of the production of switching contacts and their stock keeping is improved by the increased number of a minimum common basic size for switching contacts of various sizes.

The use of small contact element segments allows connections between them and the contact support with high binder contents and high strengths to be achieved.

The contact element segments are advantageously assembled to make up the contact element without any spaces. In this case, the segment gap between the individual contact element segments is, in technical terms, essentially zero. The close arrangement of the individual contact element segments next to one another creates an uninterrupted switching surface of virtually any desired size. It is easy to compensate for the shunts via the edges in contact with one another, produced by the contact element segments being joined together without any spaces. If the contact element segments are connected to the contact support by resistance welding, for example, it is possible to compensate for the shunts by appropriately chosen welding current control.

However, it is also possible by using individual contact element segments for the contact element to create contact elements with a discontinuous switching surface. For example, it is conceivable for contact elements with appropriate clearances or the like to be formed. This is of advantage in particular whenever the switching contact according to the invention is used in connection with other electrical components, for example on a printed-circuit board or the like.

In a further configuration, the individual contact element segments may in each case be formed from the same material or the same material composition.

In accordance with an additional feature of the invention, the individual contact element segments may be formed from different materials or material compositions.

The combination of contact element segments with the same or different material compositions allows switching contacts with different switching properties to be produced.

In accordance with another feature of the invention, the contact element may be formed from contact element segments of the same geometries in each case.

According to a further embodiment of the invention, the contact element may also be formed from contact element segments of different geometries.

The combination of contact element segments of different geometries and/or material compositions allows a mosaic of different switching properties to be produced. For example, the trailing edges of the contact element may consist of a different material than the inner regions of the contact element or the contact surface. If a resistance welding method is used for connecting the contact element to the contact support, the commuting of the arc to the trailing rails can be facilitated in this way.

The contact element segments themselves may advantageously also have regions of different material compositions.

In a further configuration, the contact element may have contact element segments of different heights. For example, in the center of the contact element or the contact surface there may be arranged contact element segments of a height which is greater than the height of the contact element segments in the edge regions of the contact element. This allows the contact resistances of the switching contact to be reduced when it is in the new state.

The contact element may advantageously be of a size greater than or equal to 16 mm2.

It is preferred for the contact element to be connected to the contact support by means of a resistance- or laser-welded connection.

The configuration of the switching contact according to the invention makes it possible with sufficient connection quality for relatively large contact elements to be connected to the contact support by means of cost-effective types of connection, such as for example resistance welding.

Other features which are considered as characteristic for the invention are set forth in the appended claims.

Although the invention is illustrated and described herein as embodied in Switching contact for electrical switching devices, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The FIGURE of the drawing is a partial perspective view of a switching contact according to the invention.

### DESCRIPTION OF THE PREFERRED EMBODIMENTS

Referring now to the sole FIGURE of the drawing in detail, there is shown a switching contact or switch contact 10, which has a contact element 12. The contact element 12 is connected to a contact support 11 by means of a suitable method of connection, for example by a resistance-welding or laser-welding process. To be able in particular to connect contact elements 12 with a switching surface greater than or equal to 16 mm² to the contact support 11 cost-effectively and with sufficient connection quality, the contact element 12 has a number of contact element segments 13. The individual contact element segments 13 are assembled to make up the contact element 12.

In the exemplary embodiment represented in the FIGURE, the contact element 12 is formed from six contact element segments 13, which in each case have a rectangular geometry and are in each case of the same height. The contact element segments 13 are assembled in such a way to make up the contact element 12 that the latter in turn has a rectangular geometry. The contact element segments 13 are all formed from the same material. However, contact element segments 13 of different geometries and/or heights and/or material compositions may also be used, so that contact elements 12 with any desired switch property can be formed. By way of example, a seventh segment 13′ is illustrated in the FIGURE, indicating a rectangular segment having a different height than the six segments 13.

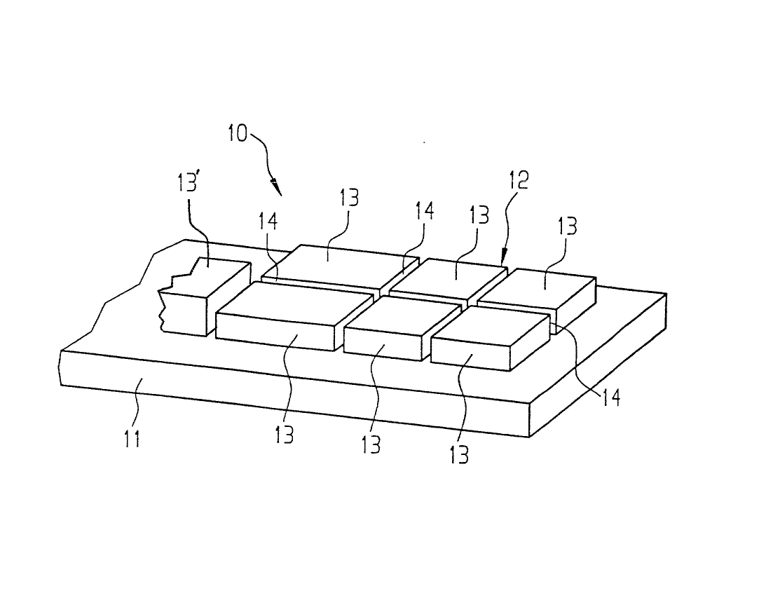

If the individual contact element segments 13 are assembled to make up a contact element 12 without any spaces, in order in this way to generate a continuous switching surface, segment gaps 14 between the individual contact element segments, represented in FIG. 1 only to illustrate the independence of the individual contact element segments 13, are, in technical terms, essentially zero. This means that the side walls of the individual contact element segments 13 lie flat against one another and that deviations from this are only within the permissible production tolerances.

The formation of the contact element 12 from a number of individual contact element segments 13 makes it possible to produce large contact elements 12, which can be connected to the contact support 11 with high binder contents and strengths.

We claim:

1. A switching contact for an electrical switching device, comprising:
a contact support;
a contact element connected to said contact support with a welded connection, said contact element being formed of a plurality of contact element segments with individual said contact element segments assembled to form said contact element.

2. The switching contact according to claim 1, wherein said contact element segments are assembled to form said contact element substantially without any spaces in between.

3. The switching contact according to claim 1, wherein said individual contact element segments are each formed from a same material.

4. The switching contact according to claim 1, wherein said individual contact element segments are each formed from a same material composition.

5. The switching contact according to claim 1, wherein said individual contact element segments are formed from mutually different materials.

6. The switching contact according to claim 1, wherein said individual contact element segments are formed from mutually different material compositions.

7. The switching contact according to claim 1, wherein said contact element segments forming said contact element have substantially identical geometries.

8. The switching contact according to claim 1, wherein said contact element segments forming said contact element have mutually different geometries.

9. The switching contact according to claim 1, wherein said contact element segments are formed with regions of different material compositions.

10. The switching contact according to claim 1, wherein said contact element segments forming said contact element have mutually different heights.

11. The switching contact according to claim 1, wherein said contact element is of a size greater than or equal to 16 mm².

12. The switching contact according to claim 1, wherein said contact element is connected to said contact support by a resistance-welded connection.

13. The switching contact according to claim 1, wherein said contact element is connected to said contact support by a laser-welded connection.
